(19) United States
(12) Patent Application Publication
(10) Pub. No.: US 2026/0266655 A1
(43) Pub. Date: Sep. 10, 2026

(54) LOW-VOLUME RADIANCE SOURCES WITH MODIFIED INTEGRATION CHAMBER GEOMETRY AND METHODS OF OPERATING THE SAME

(71) Applicant: Labsphere, Inc., North Sutton, NH (US)

(72) Inventors: Jeffrey William Holt, Concord, NH (US); Paul David Mascia, Concord, NH (US); Luke Dobrowski, Warner, NH (US)

(73) Assignee: Labsphere, Inc., North Sutton, NH (US)

(21) Appl. No.: 19/557,021

(22) Filed: Mar. 4, 2026

Related U.S. Application Data
(60) Provisional application No. 63/766,762, filed on Mar. 4, 2025.

(51) Int. Cl. G01J 1/02; F21V 15/01; G01J 1/08; G01J 1/44

(52) U.S. Cl. CPC G01J 1/0295; F21V 15/01; G01J 1/08; G01J 2001/444

(57) ABSTRACT

Certain embodiments of the present disclosure provide a novel radiance source, which may be used, in some cases, for electro-optical sensor calibration. In certain embodiments, the novel radiance source comprises a housing that defines a hollow chamber, wherein: the hollow chamber has a modified half-cylindrical shape that is non-circular in a cross-section taken transverse to a longitudinal axis that extends a length of the hollow chamber, and an interior surface of the hollow chamber is at least partially formed from a diffusely reflective material; one or more light sources configured to introduce light into the hollow chamber; and an output port at a first side of the housing.

### CROSS-REFERENCE TO RELATED APPLICATIONS

The present Application for Patent claims benefit of and priority to U.S. Provisional Application No. 63/766,762, filed March 4, 2025, which is herein incorporated by reference in its entirety.

### GOVERNMENT RIGHTS

This invention was made with government support under Government Contract No. 80GSFC20C0044 (HBG) awarded by the National Aeronautical and Space Administration (NASA) Goddard Space Flight Center (GSFC). The Government has certain rights in the invention.

### TECHNICAL FIELD

The present specification generally relates to radiance sources.

### BACKGROUND

Electro-optical sensors find use in a growing number of contexts. For example, electro-optical sensors may be found on satellites, aircrafts, ground-based vehicles, watercraft, on mobile devices, consumer electronic devices, and on stationary instrumentation. Such electro-optical sensors may include a plurality of detector elements (e.g., pixels) disposed in a focal plane to detect radiation from a scene of interest and generate an electrical signal and/or image data representative of the scene of interest. The quality and usability of the data captured by an electro-optical sensor may be dependent on both the sensor’s radiometric performance and spatial performance. Calibration plays an important role in understanding and/or improving the radiometric and spatial performance of an electro-optical sensor.

### SUMMARY

One embodiment provides a radiance source. The radiance source comprises a housing that defines a hollow chamber, wherein: the hollow chamber has a modified half-cylindrical shape that is non-circular in a cross-section taken transverse to a longitudinal axis that extends a length of the hollow chamber, and an interior surface of the hollow chamber is at least partially formed from a diffusely reflective material; one or more light sources configured to introduce light into the hollow chamber; and an output port at a first side of the housing.

Another aspect provides a method for operating a radiance source. The method comprises introducing light into a hollow chamber of the radiance source using one or more light sources; and emitting radiation from the hollow chamber through an output port at a first side of a housing defining the hollow chamber of the radiance source, wherein: an interior surface of the hollow chamber is at least partially formed from a diffusely reflective material such that the introduced light is scattered within the hollow chamber, and the hollow chamber has a modified half-cylindrical shape to increase uniformity of the radiation at the output port, the modified half-cylindrical shape of the hollow chamber being non-circular in a cross-section taken transverse to a longitudinal axis that extends a length of the hollow chamber.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 depicts an example of an integrating sphere used for electro-optical sensor calibration, according to one or more embodiments shown and described herein;

FIG. 2A is a first perspective view of an example radiance source, according to one or more embodiments shown and described herein;

FIG. 2B is a second perspective view of the example radiance source, with a portion of a housing of the example radiance source omitted to depict an interior of a hollow chamber of the example radiance source, according to one or more embodiments shown and described herein;

FIG. 2C is a top plan view of the example radiance source, according to one or more embodiments shown and described herein;

FIG. 2D is a side detail view of a portion of the example radiance source depicting example light source locations for the example radiance source, according to one or more embodiments shown and described herein;

FIG. 3 depicts an example cross-sectional profile of a hollow chamber of an example radiance source, according to one or more embodiments shown and described herein;

FIG. 4 depicts an example implementation in which a shape of a hollow chamber an example radiance source is set using a plurality of modifying elements, according to one or more embodiments shown and described herein; and

FIG. 5 depicts a method of operating a radiance source, according to one or more embodiments shown and described herein.

### DETAILED DESCRIPTION

Embodiments described herein provide low-volume radiance sources with modified integration chamber geometry and related methods of operation to help improve output port radiance uniformity, such as for electro-optical sensor calibration. In some calibration settings, a practical constraint is achieving a sufficiently uniform radiance field over a usable output area of a radiance source while also keeping the radiance source small enough for practical handling, transport, and use in facilities having limited available space. Integrating spheres are widely used to generate uniform radiance, but achieving a desired radiance uniformity over a given usable output port size often drives the integrating sphere diameter (and thus, overall volume) upward, which can increase cost and complexity and can be difficult to accommodate in constrained environments (e.g., such as thermal vacuum testing). The embodiments described herein address these issues by using a hollow chamber with a diffusely reflective interior surface and a modified half-cylindrical cross-sectional profile selected to reduce spatial nonuniformities (e.g., edge peaks, corner hot spots, and/or center gradients) at an output port of a radiance source, thereby enabling a low-volume (e.g., compact) radiance source that provides a more uniform and more usable output field.

“Calibration” refers to a process of characterizing the parameters required to understand and quantify the performance of a sensor for its intended application. With respect to an electro-optical sensor, calibration may be used to adjust and fine-tune the sensor’s response to light (e.g., radiometric calibration) and/or help to guarantee that its spatial characteristics (e.g., spatial calibration) are accurate and aligned with real-world coordinates. This process helps to ensure that the data captured by the electro-optical sensor is reliable, accurate, and suitable for its intended application(s), such as remote sensing, surveillance, and/or the like.

As used herein, the “radiometric performance” of an electro-optical sensor may refer to how well the electro-optical sensor is able to detect and measure variations in the intensity of electromagnetic radiation (e.g., essentially how well the electro-optical sensor is able to distinguish between different levels of light) across different wavelengths. For example, when an electro-optical sensor is deployed on a satellite and is used to measure radiance from Earth in multiple spectral bands (e.g., a spectral band may correspond to a range of wavelengths (or frequencies)), the electro-optical sensor may need to distinguish relatively small radiance differences between adjacent ground areas within a given spectral band (e.g., such as differences attributable to haze, thin clouds, aerosols, vegetation condition, ocean color, snow/ice, surface temperature, etc.). An electro-optical sensor having good radiometric performance may output data values that accurately track such radiance differences and do so consistently across a field of view (FOV) of the electro-optical sensor.

The “spatial performance” of an electro-optical sensor may refer to how well the electro-optical sensor is able to capture fine details and maintain geometric properties in a scene. For example, when an electro-optical sensor is deployed on a satellite and acquires image data of scenes including structured features such as coastlines, road networks, runways, rivers, and/or building edges, good spatial performance may be indicated by sharp and correctly located edges with low blur and low distortion across an FOV of the electro-optical sensor. On the other hand, degraded spatial performance may manifest as blur, geometric distortion, and/or misregistration such that a same feature appears shifted between images, between spectral bands, and/or relative to map coordinates.

In some cases, the calibration of an electro-optical sensor begins prior to the electro-optical sensor being deployed for operational use (e.g., such as in satellites and/or on airborne or remote platforms), often referred to as “pre-launch calibration” (or “ground calibration” performed on Earth before being launched into space). This calibration process may involve exposing an electro-optical sensor to known levels of radiance emitted by a radiance source in a controlled environment and measuring the electro-optical sensor’s response. For accurate pre-launch calibration, the radiance source may need to scatter light in a way that results in uniform radiance distribution (e.g., uniform light intensity distribution) (1) across the electro-optical sensor’s FOV (e.g., “spatial uniformity” in illumination) and (2) across different viewing angles from the radiance source (e.g., “angular uniformity” in illumination). For example, technical problems associated with the use of a non-uniform radiance source during pre-launch calibration may include the creation of hot spots, hot edges, and/or hot corners (e.g., areas of higher light intensity) across the electro-optical sensor’s FOV. This variation in light intensity may affect the ability of the electro-optical sensor to measure light intensity and thus, the accuracy of the calibration for the electro-optical sensor.

Unfortunately, however, there exists many technical challenges associated with providing a uniform radiance source that can be used in both ambient and vacuum conditions (e.g., such as for pre-launch calibration), and at the same time, is small enough in size to be transported to and used at various test sites, such as for continuous calibration.

An integrating sphere is one example radiance source that has traditionally been used for electro-optical sensor calibration, at least due to its ability to produce uniform radiance.

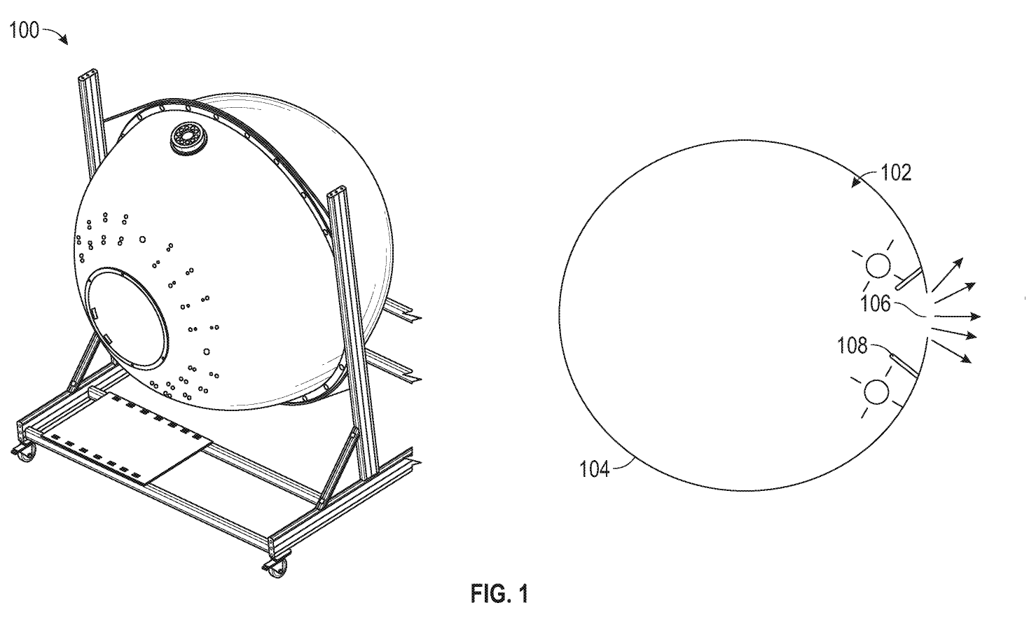

FIG. 1 depicts an example integrating sphere 100. Integrating sphere 100 defines a hollow, spherical cavity 102 with a highly reflective, inner surface 104 that may be used to diffuse and spatially mix light within cavity 102, thereby providing a uniform and diffuse light source. For example, during calibration of an electro-optical sensor (not shown), cavity 102 may be illuminated by one or more light sources disposed within the integrating sphere 100 and/or coupled to the integrating sphere 100 via one or more input ports. The inner surface 104 of the integrating sphere 100 may scatter the light in all directions, such that radiance within cavity 102 of integrating sphere 100 is substantially uniform. The electro-optical sensor may be positioned (e.g., such as outside the integrating sphere 100) to view the cavity 102 through a circular aperture 106. In particular, the circular aperture 106 may define an output aperture (also referred to herein as an “output port”) that provides an area of diffuse radiance source for calibration of the electro-optical sensor. For example, circular aperture 106 may appear, to the electro-optical sensor, as a substantially uniformly illuminated emitting surface that provides diffuse emission over a range of viewing angles for measurement.

In some cases, the integrating sphere 100 may include one or more baffles 108 (e.g., extensions of the inner surface 104 of integrating sphere 100). A baffle 108 may be disposed within the cavity 102 of the integrating sphere 100 to further help enhance the uniformity of light within integrating sphere 100. For example, even with a highly reflective inner surface, some non-uniform illumination may occur. A baffle 108 (or multiple baffles 108) may help to redistribute light and/or block irregular light paths.

Integrating spheres of various sizes may be utilized for calibration.

For example, in some cases, a smaller diameter integrating sphere (e.g., a lower volume integrating sphere) may be utilized for calibration at least due to its compact size, thereby making it easier to handle, more affordable, and requiring less space for performing calibration (e.g., including in facilities having limited floor space and/or limited thermal vacuum (TVAC) chamber volume). In addition, a smaller diameter integrating sphere may, in some implementations, provide acceptable radiance levels at an output port (e.g., such as circular aperture 106 of integrating sphere 100 in FIG. 1) using lower input power and/or reduced thermal load as compared to certain larger systems, depending on factors such as interior reflectance, port configuration, and/or a desired output port size.

A technical problem associated with the use of a smaller diameter integrating sphere, however, relates to its high port fraction. Specifically, as the integrating sphere diameter decreases for a given output port size and/or for a given set of ports, one or more ports (e.g., input ports and/or the output port) may occupy a larger percentage of the internal surface area of the integrating sphere. The increased port fraction may reduce the effective diffusely reflecting surface area available for multiple reflections and spatial mixing within a cavity (e.g., such as cavity 102 of integrating sphere 100 of FIG. 1) of the integrating sphere. As a result, light within the cavity of the integrating sphere may be less fully integrated, which, in some cases, may increase spatial and/or angular non-uniformities at the output port and reduce spatial uniformity of radiance measured by an electro-optical sensor during calibration.

While an alternative solution may include the use of a larger diameter integrating sphere to improve output uniformity, larger diameter integrating spheres may be subject to their own challenges. For example, a larger diameter integrating sphere may have lower efficiency, may be less cost effective, and/or may be more difficult to handle, transport, and/or deploy for calibration at least due to its size (e.g., available volume in many vacuum chambers, used for calibration, may be limited).

Embodiments described herein overcome the aforementioned technical problems and improve upon the state of the art by providing a radiance source, which may be used, in some cases, for electro-optical sensor calibration. The radiance source may be designed to achieve high radiance uniformity at an output port while reducing overall volume relative to traditional radiance sources (e.g., such as integrating spheres) that would otherwise be selected to achieve comparable radiance uniformity for a given usable output port size. In certain embodiments, the radiance source includes a hollow chamber (e.g., an “integration chamber”) having a diffusely reflective interior surface and a modified half-cylindrical shape that is non-circular in cross-section. In certain embodiments, the half-cylindrical shape of the hollow chamber may be set and/or adjusted to reduce nonuniformities in radiance at the output port (e.g., hot edges, hot corners, center gradients, and/or the like).

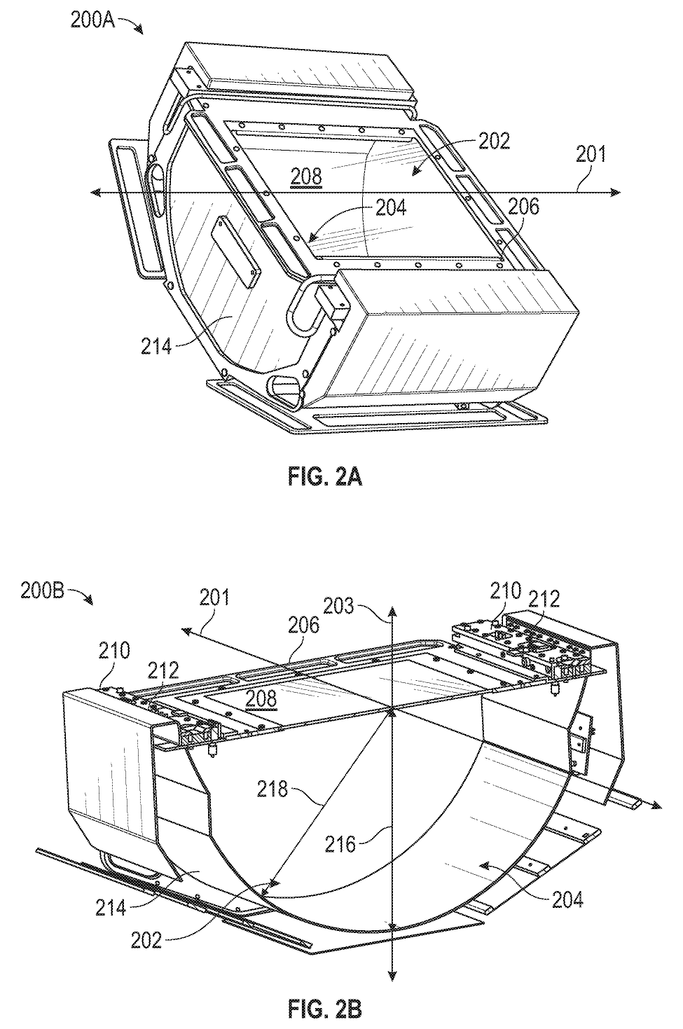

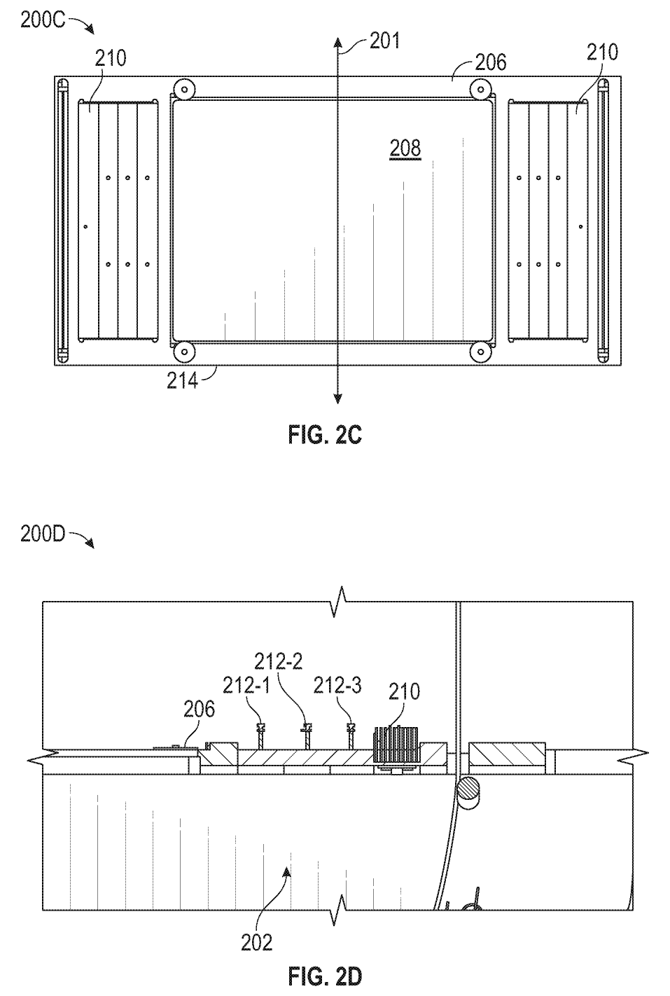

An example embodiment of this radiance source is depicted in FIGS. 2A-2D. Specifically, FIG. 2A is a first perspective view 200A of the radiance source. FIG. 2B is a second perspective view 200B of the radiance source, with a portion of a housing 214 of the radiance source omitted to illustrate an interior of a hollow chamber 202 of the radiance source. FIG. 2C is a top plan view 200C of the radiance source. FIG. 2D is a side detail view 200D of a portion of the radiance source depicting example light source 212 locations for the radiance source.

As shown in FIGS. 2A and 2B, the radiance source includes a housing 214 that encloses and defines a hollow chamber 202 extending along a longitudinal axis 201. The housing 214 includes a first side 206, and an output port 208 is formed at the first side 206. In certain embodiments, the output port 208 is rectangular in shape. In certain embodiments, a diffuser may be disposed across the output port 208. In certain embodiments, the output port 208 is positioned so that an electro-optical sensor may be placed outside the housing 214 and may view radiation emitted via the output port 208 for calibration.

Hollow chamber 202 has a half-cylindrical shape in that an interior surface 204 of hollow chamber 202 includes a curved portion facing the output port 208. However, in certain embodiments, the half-cylindrical shape of hollow chamber 202 is modified such that, in a cross-section taken transverse to the longitudinal axis 201 (e.g., as depicted in FIG. 2B), the profile is non-circular rather than a true constant-radius half-cylinder.

For example, a first dimension 216 of hollow chamber 202 may extend from the first side 206 towards a farthest point of the interior surface 204 along a centerline 203 of the hollow chamber 202. A second dimension 218 of hollow chamber 202 may extend laterally from the centerline 203 toward a side region of the interior surface 204. First dimension 216 may be different than second dimension 218. In certain embodiments, first dimension 216 is greater than second dimension 218. As such, the cross-sectional profile of hollow chamber 202 may be characterized as having side regions that are displaced inward relative to a true constant-radius half-cylinder and a middle region that is displaced away from first side 206.

In certain embodiments, the modified half-cylindrical shape of hollow chamber 202 helps to reduce nonuniformities in radiance at output port 208 (e.g., hot edges, hot corners, and/or center gradients) as compared to a radiance source having a true constant-radius half-cylindrical chamber of similar size and port geometry. In certain embodiments, the reduction in nonuniformities increases radiance uniformity over the output port 208. In certain embodiments, the reduced nonuniformities enable increased (e.g., larger) usable area at the output port 208 that meets a target uniformity specification and/or enable a reduction in overall volume of the radiance source while maintaining a desired radiance uniformity for calibration of an electro-optical sensor.

In certain other embodiments, the shape of the hollow chamber 202 may have an arbitrary shape (e.g., different than the shape shown in FIGS. 2A-2D) that is structured to help achieve high radiance uniformity.

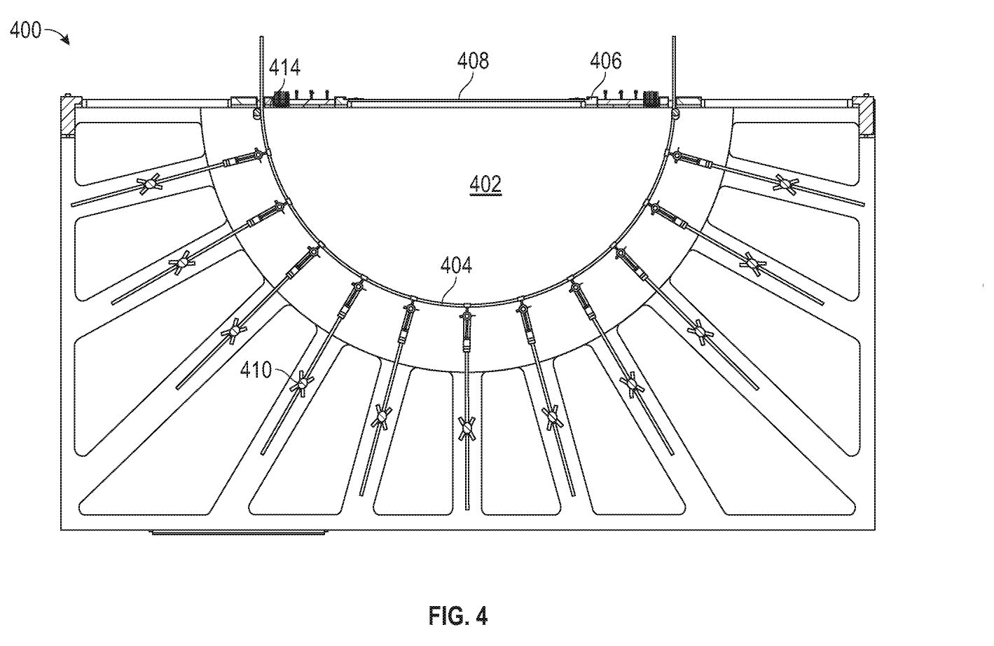

In certain embodiments, a shape of the hollow chamber 202 is adjustable. For example, one or more regions of the interior surface 204 may be repositioned in response to an applied force to change the cross-sectional profile of the hollow chamber 202. In certain embodiments, the applied force is provided by one or more modifying elements coupled to modifiable wall portion(s) of the interior surface 204. In certain embodiments, the applied force may be attributable to external conditions and/or loads (e.g., pressure changes, temperature changes, and/or mechanical forces, to name a few). Adjusting the shape of the hollow chamber 202 may change the radiance distribution at the output port 208, which may be observed by an electro-optical sensor during calibration. Additional details related to adjustment of the shape of the hollow chamber 202 are provided herein with respect to FIG. 4.

Interior surface 204 of the hollow chamber 202 may define an integration surface that faces an interior volume of hollow chamber 202. In certain embodiments, interior surface 204 is at least partially formed from a diffusely reflective material such that light introduced into the hollow chamber 202 is scattered by interior surface 204 to help promote spatial mixing within hollow chamber 202 prior to emission through output port 208. In certain embodiments, the diffusely reflective material of interior surface 204 comprises a Lambertian diffuse coating.

In certain embodiments, the hollow chamber 202 may include opposed end surfaces at opposite ends of the half-cylindrical region along the longitudinal axis 201 (e.g., the generally planar end surfaces visible in FIG. 2B). In certain embodiments, one or both of the end surfaces may comprise a mirrored (e.g., specularly reflective) surface to reflect light back into the hollow chamber 202 and help reduce end losses, thereby improving radiance uniformity along the longitudinal axis 201. In certain embodiments, one or both of the end surfaces comprise a diffusely reflective surface (e.g., coated with the same or a similar diffusely reflective material as the interior surface 204 of the hollow chamber 202) to promote additional spatial mixing.

The radiance source further includes source modules 210 positioned adjacent the output port 208 on the first side 206. For example, in certain embodiments, the radiance source includes two source modules 210, such as a first source module 210 and a second source module 210 disposed on opposite sides of the output port 208 (e.g., left and right sides in the second perspective view 200B of FIG.). Each source module 210 may include one or more light sources 212 (e.g., one or more light sources 212 may be part of the source modules 210). Thus, in certain embodiments, a first subset (e.g., less than all) of light sources 212 and a second subset of lights sources 212 may be disposed on opposite sides of output port 208. The light sources 212 may be configured to introduce light into the hollow chamber 202.

In certain embodiments, light sources 212 include one or more light-emitting diodes (LEDs). In certain embodiments, light sources 212 include one or more quartz tungsten halogen (QTH) bulbs.

In certain embodiments, the light sources 212 may be implemented as multiple discrete emitters distributed along the longitudinal axis 201, such as to improve radiance uniformity along a length of the output port 208. In certain embodiments, as depicted in the detail view of FIG. 2D, light sources 212 may be mounted at selectable positions relative to the interior surface 204 (e.g., side portions of interior surface 204) of the hollow chamber 202 and/or relative to the output port 208. For example, a given light source 212 may be mounted at any of a plurality of discrete locations, such as a first position shown via light source 212-1, a second position shown via light source 212-2, or a third position shown via light source 212-3 in FIG. 2D. In certain embodiments, a position of a given light source 212 may affect a radiance distribution at the output port 208. For example, in certain embodiments, changing a distance between the light source 212 and a nearest region of the interior surface 204 may change a spatial profile of radiance at the output port 208. In certain embodiments, the effect of a position of a light source 212 on the output radiance distribution may be more strongly influenced by the distance between the light source 212 and the interior surface 204 than by the distance between the light source 212 and the output port 208 (e.g., such as when a distance from the interior surface 204 to the output port 208 is fixed). In certain embodiments, the modified half-cylindrical shape of hollow chamber 202 may be set in view of a selected position of the light source 212.

In certain embodiments, although not shown in FIGS. 2A-2D, the radiance source may further include additional optical features to help reduce nonuniformities in radiance at the output port 208. For example, in certain embodiments, one or more baffles may be disposed within hollow chamber 202. In certain embodiments, the baffle(s) may be coupled to and/or extend from interior surface 204. In certain embodiments, the baffle(s) may be coupled to and/or extend from an underside of first side 206. In certain embodiments, the baffle(s) may be used to block direct view of one or more light sources 212 from the output port 208 and/or to further promote radiance uniformity at the output port 208.

In certain embodiments, the radiance source may have a volume that is significantly less than the volume of traditional radiance sources, such as integrating spheres (e.g., integrating sphere 100 depicted and described above with respect to FIG. 1). For example, an example larger diameter (e.g., 65 inch (in) diameter) integrating sphere may have a volume of 144,000 in³, an example smaller diameter (e.g., 40 in diameter) integrating sphere may have a volume of 33,510 in³, and the radiance source depicted herein, e.g. FIG. 2A, may have a volume of 5,750 in³. Thus, in certain embodiments, the radiance source described herein may comprise approximately 80% less volume than the smaller diameter integrating sphere and approximately 95% less volume than the larger diameter integrating sphere, while also maintaining a comparable/large usable aperture, improving uniformity, and achieving higher throughput (e.g., efficiency) for a given power input.

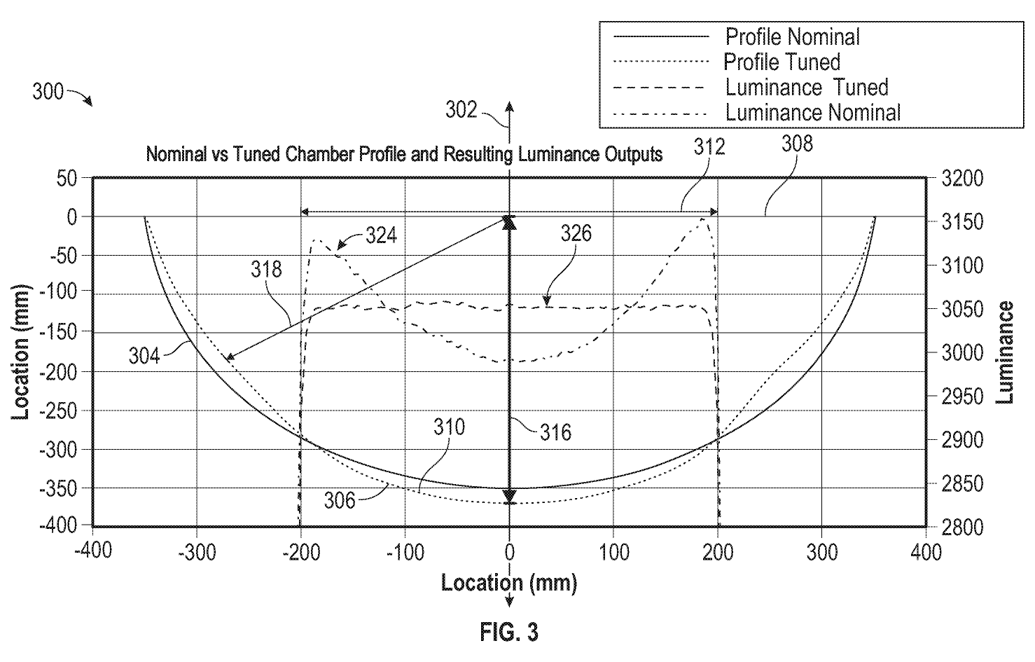

FIG. 3 depicts an example cross-sectional profile 300 of a hollow chamber of the radiance source described herein (e.g., such as hollow chamber 202 of the radiance source depicted and described above with respect to FIGS. 2A-2D). In certain embodiments, the cross-sectional profile 300 is taken transverse to the longitudinal axis of the hollow chamber.

As shown in FIG. 3, centerline 302 represents a midpoint of the cross-sectional profile 300. Curve 304 represents an example true half-cylindrical shape for the hollow chamber in which an interior surface 310 of the hollow chamber has a substantially constant radius (e.g., 350 millimeters (mm)) in the cross-sectional profile 300. Curve 306 represents an example modified half-cylindrical shape of the hollow chamber in which the interior surface 310 deviates from the true half-cylindrical shape such that the cross-sectional profile is non-circular.

The modified half-cylindrical shape (e.g., represented by curve 306) may be characterized by (1) a first dimension 316 extending from a first side 308 of the radiance source towards a farthest point of the interior surface 310 along the centerline 302 and (2) a second dimension 318 extending laterally from the centerline 302 toward a side portion of the interior surface 310. In certain embodiments, the first dimension 316 is greater than the second dimension 318. Stated differently, relative to the true half-cylindrical shape (e.g., represented by curve 304), the modified half-cylindrical shape includes side portions that are displaced inward and a middle portion that is displaced away from the first side 308.

FIG. 3 further depicts example radiance uniformity profiles 324 and 326 at an output port 312 for the true half-cylindrical shape (e.g., represented by curve 304) and the modified half-cylindrical shape (e.g., represented by curve 306), respectively. For example, as shown in FIG. 3, radiance uniformity profile 324 corresponding to the true half-cylindrical shape (e.g., represented by curve 304) may exhibit nonuniformity across the output port 312. By contrast, radiance uniformity profile 326 corresponding to the modified half-cylindrical shape (e.g., represented by curve 306) may be substantially flatter across the output port 312, in some cases, indicating near-perfect radiance uniformity over a usable area of the output port 312.

FIG. 4 depicts an example implementation 400 in which a shape of a hollow chamber 402, of the radiance source described herein, is set using a plurality of modifying elements 410. As shown, hollow chamber 402 is defined within a housing 414 and includes an interior surface 404 facing an interior volume of the hollow chamber 402. An output port 408 is formed at a first side 406 of the housing 414 such that radiation emitted from within the hollow chamber 402 may exit the housing 414 via the output port 408.

The interior surface 404 includes a modifiable wall portion (or multiple modifiable wall portions) that may be repositioned to change a cross-sectional profile of the hollow chamber 402. The modifying elements 410 are arranged at a plurality of locations around the curved portion of the interior surface 404 and are mechanically coupled between the housing 414 and the modifiable wall portion(s). In certain embodiments, individual modifying elements 410 may be operated to apply a local force to the modifiable wall portion(s), thereby locally changing curvature and collectively setting a desired modified half-cylindrical shape for hollow chamber 402. In certain embodiments, the modifying elements 410 may include push rods, threaded adjusters (e.g., screw-driven adjusters), actuators (e.g., linear actuators), and/or the like.

In certain embodiments, by selectively setting respective ones of the modifying elements 410, the cross-sectional profile of the hollow chamber 402 may be tuned to reduce nonuniformities in radiance at the output port 408. For example, in certain embodiments, a first subset of the modifying elements 410 may be set to displace side portions of the interior surface 404 inward, while a second subset of the modifying elements 410 may be set to displace a middle portion of the interior surface 404 away from the first side 406 (e.g., to achieve the modified half-cylindrical shape represented by curve 306 in FIG. 3), thereby helping to reduce edge peaks and/or center gradients in radiance at the output port 408.

In certain embodiments, the radiance source further includes a controller (not shown in FIG. 4) that is communicatively coupled to the modifying elements 410. The controller may be configured to control operation of the modifying elements 410 based on a measured radiance distribution at the output port 408. For example, a measurement device (not shown) such as a calibrated camera, radiometer, and/or photodetector array may be positioned to view the output port 408 and measure radiance as a function of position across the output port 408. The controller may determine one or more nonuniformity metrics from the measured radiance distribution and generate control signals to change one or more set positions of the modifying elements 410. In some embodiments, the controller iteratively repeats radiance measurement and modification of the set positions of the modifying elements 410 until a target radiance uniformity at the output port 408 is achieved.

During operation of the radiance source depicted and described herein with respect to FIGS. 2A-2D, 3, and 4, one or more light sources may introduce light into the hollow chamber of the radiance source. The introduced light may undergo multiple diffuse reflections from the diffusely reflective interior surface of the hollow chamber, thereby promoting spatial mixing within the hollow chamber prior to emission through the output port. In certain embodiments, an electro-optical sensor to be calibrated may be positioned outside the housing at the first side to view radiation emitted via the output port.

### Example Method for Operating a Radiance Source

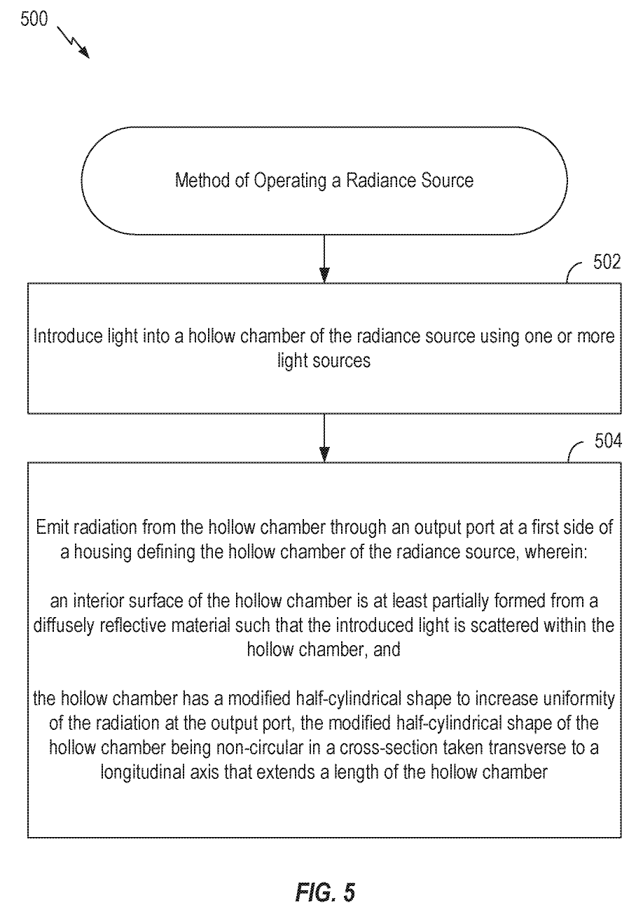

FIG. 5 depicts a method of operating a radiance source, such as the radiance source depicted and described herein with respect to FIGS. 2A-2D, 3, and 4.

Method 500 begins at block 502 with introducing light into a hollow chamber of the radiance source using one or more light sources.

Method 500 then proceeds to block 504 with emitting radiation from the hollow chamber through an output port at a first side of a housing defining the hollow chamber of the radiance source. In certain embodiments, an interior surface of the hollow chamber is at least partially formed from a diffusely reflective material such that the introduced light is scattered within the hollow chamber. In certain embodiments, the hollow chamber has a modified half-cylindrical shape to increase uniformity of the radiation at the output port. In certain embodiments, the modified half-cylindrical shape of the hollow chamber is non-circular in a cross-section taken transverse to a longitudinal axis that extends a length of the hollow chamber.

In certain embodiments, method 500 further comprises: setting a shape of the hollow chamber to be the modified half-cylindrical shape using a plurality of modifying elements coupled to one or more regions of a modifiable wall portion of the hollow chamber.

In certain embodiments, the plurality of modifying elements comprise at least one of: one or more push rods; one or more threaded adjusters; or one or more actuators.

In certain embodiments, method 500 further comprises: determining a radiance distribution of the radiation emitted via the output port; and further adjusting the shape of the hollow chamber using the plurality of modifying elements based on the radiance distribution.

In certain embodiments, in the cross-section taken transverse to the longitudinal axis, the hollow chamber defines: a first dimension that extends from the first side of the housing to a farthest point of the interior surface along a centerline of the hollow chamber; and a second dimension that extends laterally from the centerline to a side region of the interior surface, the first dimension being greater than the second dimension.

In certain embodiments, a shape of the output port comprises a rectangular shape.

In certain embodiments, a diffuser is disposed across the output port.

In certain embodiments, the one or more light sources comprise a plurality of light sources, and a first subset of light sources of the plurality of light sources and a second subset of light sources of the plurality of light sources are disposed on opposite sides of the output port.

In certain embodiments, the one or more light sources comprise a plurality of light sources, and the plurality of light sources are disposed along the longitudinal axis of the hollow chamber.

In certain embodiments, the one or more light sources comprise at least one of: one or more light-emitting diodes (LEDs); or one or more quartz tungsten halogen (QTH) bulbs.

In certain embodiments, the diffusely reflective material of the interior surface of the hollow chamber comprises a Lambertian diffuse coating.

In certain embodiments, the radiance source comprises at least one baffle disposed within the hollow chamber

Note that FIG. 5 is just one example of a method, and other methods including fewer, additional, or alternative operations are possible consistent with this disclosure.

It should now be understood that the present disclosure provides low-volume (e.g., compact) radiance sources and related operating techniques that improve radiance uniformity at an output port without relying on the size increases typically associated with integrating sphere-based solutions. In the described embodiments, improved uniformity is achieved by using a hollow chamber having a diffusely reflective interior surface and a modified half-cylindrical cross-sectional profile that departs from a true constant-radius half-cylinder. In certain embodiments, the chamber shape is set by a modifiable wall portion and associated modifying elements, optionally under control of a controller that uses feedback from measured radiance at the output port. Additional disclosed features, such as a diffuser at the output port, one or more baffles within the hollow chamber, and distributed arrangements of light sources, may be used alone or in combination to further reduce spatial nonuniformities, increase usable output area, and, in some cases, support repeatable calibration of electro-optical sensors.

### Example Clauses

Implementation examples are described in the following numbered clauses:

Clause 1: A radiance source comprising: a housing that defines a hollow chamber, wherein: the hollow chamber has a modified half-cylindrical shape that is non-circular in a cross-section taken transverse to a longitudinal axis that extends a length of the hollow chamber, and an interior surface of the hollow chamber is at least partially formed from a diffusely reflective material; one or more light sources configured to introduce light into the hollow chamber; and an output port at a first side of the housing.

Clause 2: The radiance source of Clause 1, wherein, in the cross-section taken transverse to the longitudinal axis, the hollow chamber defines: a first dimension that extends from the first side of the housing to a farthest point of the interior surface along a centerline of the hollow chamber; and a second dimension that extends laterally from the centerline to a side region of the interior surface, the first dimension being greater than the second dimension.

Clause 3: The radiance source of any one of Clauses 1-2, wherein: the interior surface of the hollow chamber comprises a modifiable wall portion, and the modifiable wall portion defines at least part of the modified half-cylindrical shape.

Clause 4: The radiance source of Clause 3, further comprising: a plurality of modifying elements coupled to one or more regions of the modifiable wall portion, wherein the plurality of modifying elements are configured to set the modified half-cylindrical shape.

Clause 5: The radiance source of Clause 4, wherein the plurality of modifying elements comprise at least one of: one or more push rods; one or more threaded adjusters; or one or more actuators.

Clause 6: The radiance source of any one of Clauses 4-5, further comprising a controller configured to control the plurality of modifying elements based on a measured radiance distribution at the output port.

Clause 7: The radiance source of any one of Clauses 1-6, wherein a shape of the output port comprises a rectangular shape.

Clause 8: The radiance source of any one of Clauses 1-7, further comprising a diffuser disposed across the output port.

Clause 9: The radiance source of any one of Clauses 1-8, wherein: the one or more light sources comprise a plurality of light sources, and a first subset of light sources of the plurality of light sources and a second subset of light sources of the plurality of light sources are disposed on opposite sides of the output port.

Clause 10: The radiance source of any one of Clauses 1-9, wherein: the one or more light sources comprise a plurality of light sources, and the plurality of light sources are disposed along the longitudinal axis of the hollow chamber.

Clause 11: The radiance source of any one of Clauses 1-10, wherein the one or more light sources comprise at least one of: one or more LEDs; or one or more QTH bulbs.

Clause 12: The radiance source of any one of Clauses 1-11, wherein the diffusely reflective material of the interior surface of the hollow chamber comprises a Lambertian diffuse coating.

Clause 13: The radiance source of any one of Clauses 1-12, further comprising at least one baffle disposed within the hollow chamber.

Clause 14: A method of operating a radiance source comprising: introducing light into a hollow chamber of the radiance source using one or more light sources; and emitting radiation from the hollow chamber through an output port at a first side of a housing defining the hollow chamber of the radiance source, wherein: an interior surface of the hollow chamber is at least partially formed from a diffusely reflective material such that the introduced light is scattered within the hollow chamber, and the hollow chamber has a modified half-cylindrical shape to increase uniformity of the radiation at the output port, the modified half-cylindrical shape of the hollow chamber being non-circular in a cross-section taken transverse to a longitudinal axis that extends a length of the hollow chamber.

Clause 15: The method of Clause 14, further comprising: setting a shape of the hollow chamber to be the modified half-cylindrical shape using a plurality of modifying elements coupled to one or more regions of a modifiable wall portion of the hollow chamber.

Clause 16: The method of Clause 15, wherein the plurality of modifying elements comprise at least one of: one or more push rods; one or more threaded adjusters; or one or more actuators.

Clause 17: The method of any one of Clauses 15-16, further comprising: determining a radiance distribution of the radiation emitted via the output port; and further adjusting the shape of the hollow chamber using the plurality of modifying elements based on the radiance distribution.

Clause 18: The method of any one of Clauses 15-17, wherein, in the cross-section taken transverse to the longitudinal axis, the hollow chamber defines: a first dimension that extends from the first side of the housing to a farthest point of the interior surface along a centerline of the hollow chamber; and a second dimension that extends laterally from the centerline to a side region of the interior surface, the first dimension being greater than the second dimension.

Clause 19: The method of any one of Clauses 14-18, wherein a shape of the output port comprises a rectangular shape.

Clause 20: The method of any one of Clauses 14-19, wherein a diffuser is disposed across the output port.

Clause 21: The method of any one of Clauses 14-20, wherein: the one or more light sources comprise a plurality of light sources, and a first subset of light sources of the plurality of light sources and a second subset of light sources of the plurality of light sources are disposed on opposite sides of the output port.

Clause 22: The method of any one of Clauses 14-21, wherein: the one or more light sources comprise a plurality of light sources, and the plurality of light sources are disposed along the longitudinal axis of the hollow chamber.

Clause 23: The method of any one of Clauses 14-22, wherein the one or more light sources comprise at least one of: one or more LEDs; or one or more QTH bulbs.

Clause 24: The method of any one of Clauses 14-23, wherein the diffusely reflective material of the interior surface of the hollow chamber comprises a Lambertian diffuse coating.

Clause 25: The method of any one of Clauses 14-24, wherein the radiance source comprises at least one baffle disposed within the hollow chamber.

### Additional Considerations

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A radiance source comprising:
a housing that defines a hollow chamber, wherein:
the hollow chamber has a modified half-cylindrical shape that is non-circular in a cross-section taken transverse to a longitudinal axis that extends a length of the hollow chamber, and
an interior surface of the hollow chamber is at least partially formed from a diffusely reflective material;
one or more light sources configured to introduce light into the hollow chamber; and
an output port at a first side of the housing.

2. The radiance source of claim 1, wherein, in the cross-section taken transverse to the longitudinal axis, the hollow chamber defines:
a first dimension that extends from the first side of the housing to a farthest point of the interior surface along a centerline of the hollow chamber; and
a second dimension that extends laterally from the centerline to a side region of the interior surface, the first dimension being greater than the second dimension.

3. The radiance source of claim 1, wherein:
the interior surface of the hollow chamber comprises a modifiable wall portion, and
the modifiable wall portion defines at least part of the modified half-cylindrical shape.

4. The radiance source of claim 3, further comprising:
a plurality of modifying elements coupled to one or more regions of the modifiable wall portion,
wherein the plurality of modifying elements are configured to set the modified half-cylindrical shape.

5. The radiance source of claim 4, wherein the plurality of modifying elements comprise at least one of:
one or more push rods;
one or more threaded adjusters; or
one or more actuators.

6. The radiance source of claim 4, further comprising a controller configured to control the plurality of modifying elements based on a measured radiance distribution at the output port.

7. The radiance source of claim 1, wherein a shape of the output port comprises a rectangular shape.

8. The radiance source of claim 1, further comprising a diffuser disposed across the output port.

9. The radiance source of claim 1, wherein:
the one or more light sources comprise a plurality of light sources, and
a first subset of light sources of the plurality of light sources and a second subset of light sources of the plurality of light sources are disposed on opposite sides of the output port.

10. The radiance source of claim 1, wherein:
the one or more light sources comprise a plurality of light sources, and
the plurality of light sources are disposed along the longitudinal axis of the hollow chamber.

11. The radiance source of claim 1, wherein the one or more light sources comprise at least one of:
one or more light-emitting diodes (LEDs); or
one or more quartz tungsten halogen (QTH) bulbs.

12. The radiance source of claim 1, wherein the diffusely reflective material of the interior surface of the hollow chamber comprises a Lambertian diffuse coating.

13. The radiance source of claim 1, further comprising at least one baffle disposed within the hollow chamber.

14. A method of operating a radiance source comprising:
introducing light into a hollow chamber of the radiance source using one or more light sources; and
emitting radiation from the hollow chamber through an output port at a first side of a housing defining the hollow chamber of the radiance source, wherein:
an interior surface of the hollow chamber is at least partially formed from a diffusely reflective material such that the introduced light is scattered within the hollow chamber, and
the hollow chamber has a modified half-cylindrical shape to increase uniformity of the radiation at the output port, the modified half-cylindrical shape of the hollow chamber being non-circular in a cross-section taken transverse to a longitudinal axis that extends a length of the hollow chamber.

15. The method of claim 14, further comprising:
setting a shape of the hollow chamber to be the modified half-cylindrical shape using a plurality of modifying elements coupled to one or more regions of a modifiable wall portion of the hollow chamber.

16. The method of claim 15, wherein the plurality of modifying elements comprise at least one of:
one or more push rods;
one or more threaded adjusters; or
one or more actuators.

17. The method of claim 15, further comprising:
determining a radiance distribution of the radiation emitted via the output port; and
further adjusting the shape of the hollow chamber using the plurality of modifying elements based on the radiance distribution.

18. The method of claim 15, wherein, in the cross-section taken transverse to the longitudinal axis, the hollow chamber defines:
a first dimension that extends from the first side of the housing to a farthest point of the interior surface along a centerline of the hollow chamber; and
a second dimension that extends laterally from the centerline to a side region of the interior surface, the first dimension being greater than the second dimension.

19. The method of claim 14, wherein a shape of the output port comprises a rectangular shape.

20. The method of claim 14, wherein a diffuser is disposed across the output port.
